(19) United States
(12) Patent Application Publication
(10) Pub. No.: US 2008/0149587 A1
(43) Pub. Date: Jun. 26, 2008

(54) Bayonet Closure, Bottle Fitting and Methods of Using the Same

(76) Inventors: Steven L. Sweeton, Lake Winnebago, MO (US); David L. Dejong, Ogden, UT (US); Robert J. Good, Lee's Summit, MO (US)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/960,270

(22) Filed: Dec. 19, 2007

Related U.S. Application Data
(60) Provisional application No. 60/871,425, filed on Dec. 21, 2006.

(51) Int. Cl. B65D 41/06; B67D 5/40; B23P 19/04

(52) U.S. Cl. 215/332; 222/383.1; 29/700

(57) ABSTRACT

A container closure system including a container cap and a container closure may be frictionally mated such that projections in the container closure removably lock interior projections of an opening in the container cap in spaces defined in the container closure projections to hold the container cap on the container closure.

### CROSS-REFERENCE TO RELATED APPLICATIONS

This application claims the benefit of U.S. Provisional Application No. 60/871,425, entitled “BAYONET CLOSURE, BOTTLE FITTING AND METHODS OF USING THE SAME,” filed Dec. 21, 2006, and incorporates the same herein by reference in its entirety.

### BACKGROUND

1. Field of the Invention

The present invention relates to container closures and closure systems, and more particularly to a bayonet closure system for attaching a cap, trigger, pump, or other device to a bottle or container.

2. State of the Art

Container closure systems are well known and are widely used in many industries throughout the world. Some container closure systems often include a container configured with threading about an opening of the container and a corresponding container cap having threading configured to mate with the threading on the container such that the cap may be screwed onto the container to close the container. In other instances, a container may include snap fittings upon which a cap having corresponding snap fittings may be engaged to fit the cap to the container. Other container closures and closure systems may also be used.

While various container closure systems are widely available, there is a need for improved container closure systems capable of improving automatic filling, closing, or coupling of the containers to a cap or other container closure.

### BRIEF DESCRIPTION OF THE SEVERAL VIEWS OF THE DRAWINGS

FIG. 1 illustrates a container cap configured according to embodiments of the invention;

FIG. 2 illustrates a side view of a container cap according to embodiments of the invention;

FIG. 3 illustrates a front view of a container cap according to embodiments of the invention;

FIG. 4 illustrates a rear view of a container cap according to embodiments of the invention;

FIG. 5 illustrates a cross-sectional view of a container cap according to embodiments of the invention;

FIG. 6 illustrates a cross-sectional view of a container cap according to embodiments of the invention;

FIG. 7 illustrates a bottom view of a container cap according to embodiments of the invention;

FIG. 8 illustrates a top view of a container cap according to embodiments of the invention;

FIG. 9 illustrates a side view of a container closure according to embodiments of the invention;

FIG. 10 illustrates a side view of a container closure according to embodiments of the invention;

FIG. 11 illustrates a top-down view of a container closure according to embodiments of the invention;

FIG. 12 illustrates a horizontal cross-sectional view of a container closure according to embodiments of the invention;

FIG. 13 illustrates a vertical cross-sectional view of a container closure according to embodiments of the invention;

FIG. 14 illustrates a perspective view of a container closure according to embodiments of the invention;

FIG. 15 illustrates a top view of a container cap according to embodiments of the invention; and

FIG. 16 illustrates a container cap connecting a container attachment to a container according to various embodiments of the invention.

### DETAILED DESCRIPTION OF THE INVENTION

According to various embodiments of the invention, a container closure system may include a container configuration and a container cap configured to mate with or otherwise attach to the container configuration. In some embodiments of the invention the container cap may provide a closure for the container. In still other embodiments of the invention, the container cap may provide a method for attaching another device to a container. For example, a trigger sprayer may be attached to a container using a container closure system according to various embodiments of the invention.

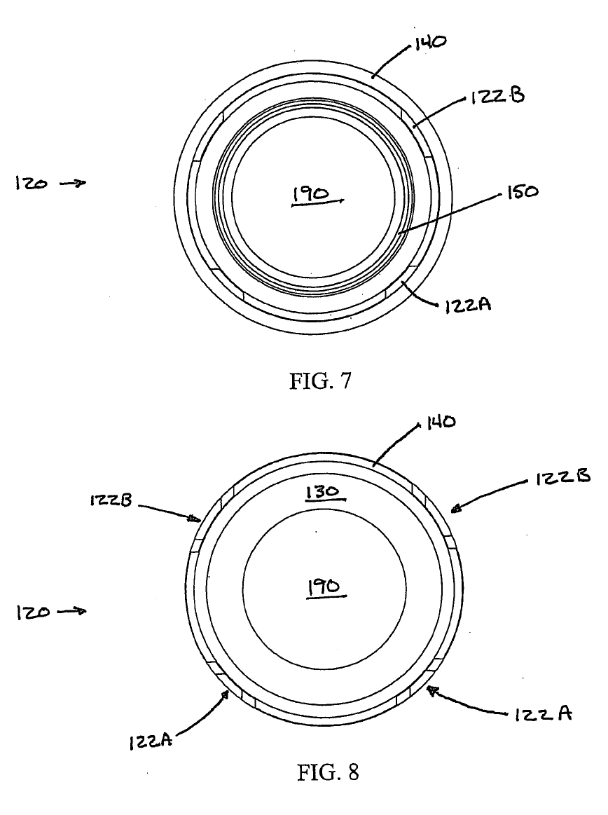

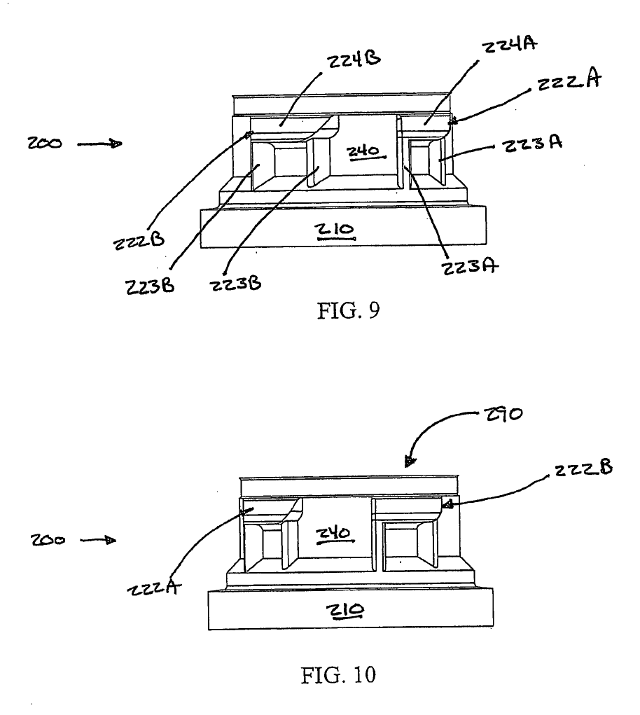

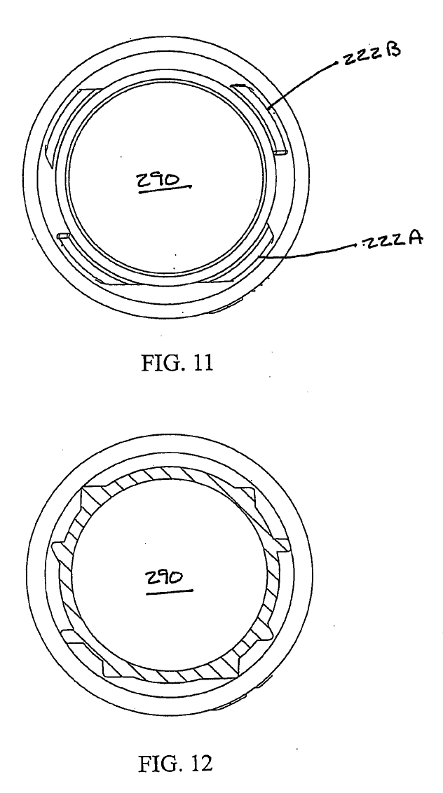

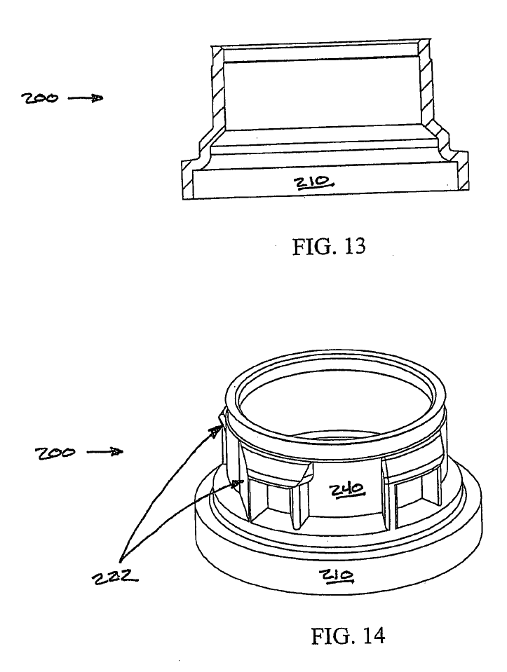

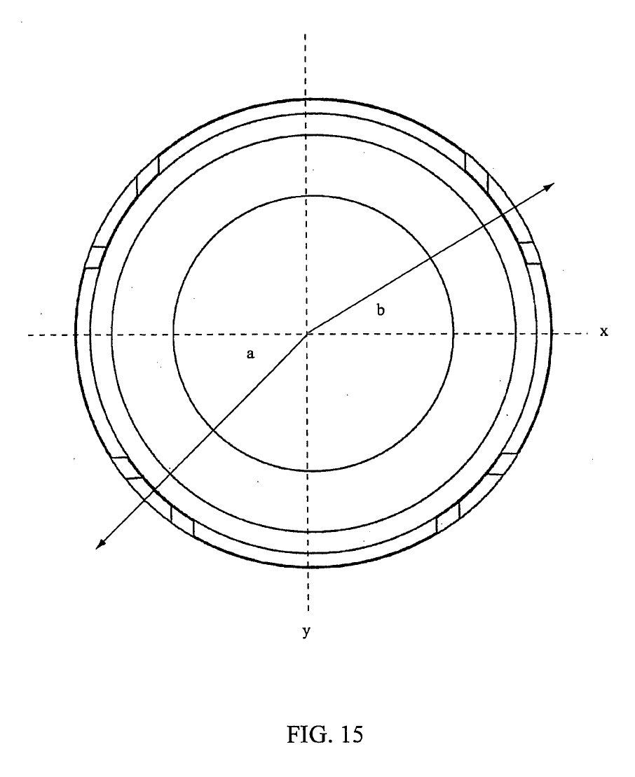

According to particular embodiments of the invention, a container closure system may include a container and a container cap. FIGS. 1 through 8 illustrate a container cap 120 according to particular embodiments of the invention. The container cap may mate with or otherwise attach to a container. According to some embodiments of the invention, a container may include a container having an opening configured as illustrated in FIGS. 9 through 14. The configurations may be used for mating with a container cap 120.

According to various embodiments of the invention, a container cap 120 may have a circular shape as illustrated in FIGS. 1 through 8. The container cap 120 may include a top surface 130 connected to or integral with a side wall 140. The side wall 140 may be circular in shape and may define a space within the circumference of the side wall 140 which is on the interior of the container cap 120. The top surface 130 of the container cap 120 may be solid or may include one or more openings 190 through the top surface 130 into the space defined by the circumference of the side wall 140. As illustrated in FIGS. 1 through 8, the side wall 140 may also include one or more slanted portions 142 defining an alternate interior space within the circumference of the one or more slanted portions 142. While a single slanted portion 142 of the side wall 140 is illustrated in FIGS. 1 through 8, it is understood that the side wall 140 may not include such slanted portion 142, may include one or more such slanted portions 142, or may include other protrusions or indentations as desired.

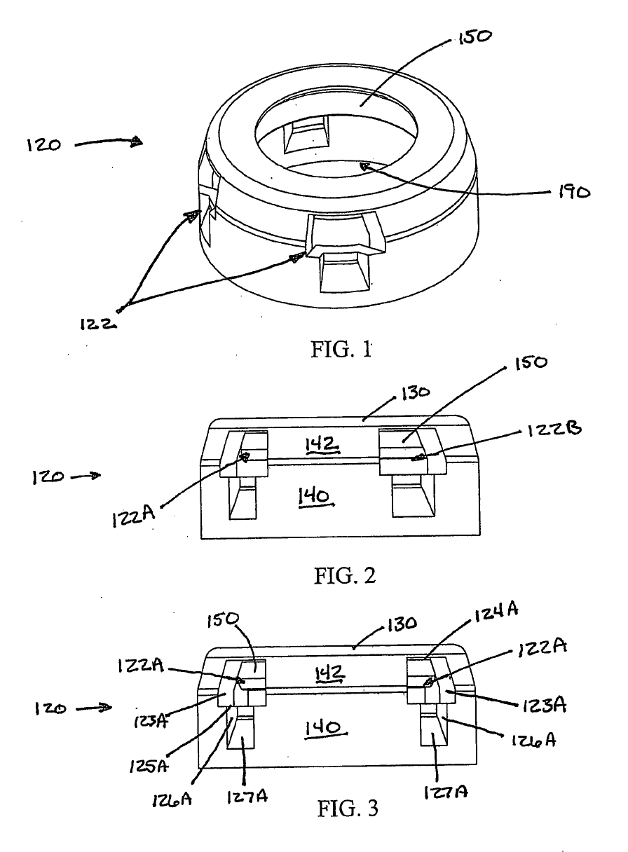

A container cap 120 according to particular embodiments of the invention may include one or more openings 122 through at least a portion of the side wall 140 wherein the openings communicate with an interior space of the container cap 120 defined by the side walls 140 and slanted portions 142. As illustrated in FIGS. 2 through 8, a container cap 120 may include a first pair of openings 122A and a second pair of openings 122B. The first pair of openings 122A may be positioned within the side walls 140 of the container cap 120 as illustrated particularly in FIGS. 3, 7, and 8.

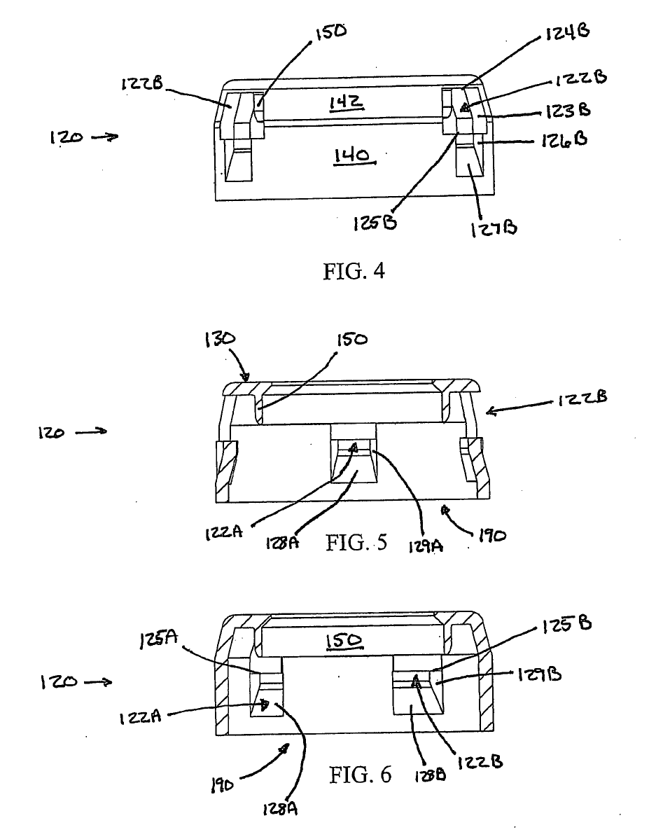

A container cap 120 may also include a second pair of openings 122B positioned within the side walls 140 of the container cap 120 as illustrated particularly by FIGS. 4, 7, and 8. The second pair of openings 122B may be positioned in a rear portion of the container cap 120.

The first pair of openings 122A may include opposing upper sidewalls 123A, upper surface 124A, lower surface 125A, lower side walls 126A, and lower slanting portion 127A as illustrated in FIG. 3. The upper sidewalls 123A may include a slant or taper from an exterior portion of the side wall 140 to an interior portion of the side wall 140. In some instances, the taper may be such that the width of the openings 122A on the exterior portion of the side wall 140 is wider than the width of the openings 122A on an interior portion of the side wall 140. The taper of each respective upper sidewall 123A may be identical or dissimilar as desired. The upper sidewalls 123A combined with the upper surface 124A and lower surface 125A may define an opening through the side wall 140 into the interior portion of the container cap 120 defined by the interior of side wall 140. The lower side walls 126A of the first pair of openings 122A combined with the lower slanting portion 127A may define a notch in the side wall 140 and a corresponding projection into an interior of the container cap 120 defined by the interior of side wall 140. For example, the opposite side of the lower slanting portion 127A may include an interior slanting portion 128A having interior side walls 129A forming a projection as illustrated in FIG. 5. The interior slanting portion 128A may include one or more surfaces having different angles and slopes relative to the interior slanting portion 128A.

The second pair of openings 122B may include opposing upper sidewalls 123B, upper surface 124B, lower surface 125B, lower side walls 126B, and lower slanting portion 127B as illustrated in FIG. 6. The upper sidewalls 123B may include a slant or taper from an exterior portion of the side wall 140 to an interior portion of the side wall 140. In some instances, the taper may be such that the width of the openings 122B on the exterior portion of the side wall 140 is wider than the width of the openings 122B on an interior portion of the side wall 140. The taper of each respective upper sidewall 123B may be identical or dissimilar as desired. The upper sidewalls 123B combined with the upper surface 124B and lower surface 125B may define an opening through the side wall 140 into the interior portion of the container cap 120 defined by the interior of side wall 140. The lower side walls 126B of the first pair of openings 122B combined with the lower slanting portion 127B may define a notch in the side wall 140 and a corresponding projection into an interior of the container cap 120 defined by the interior of side wall 140. For example, the opposite side of the lower slanting portion 127B may include an interior slanting portion 128B having interior side walls 129B forming a projection as illustrated in FIG. 5. The interior slanting portion 128B may include one or more surfaces having different angles and slopes relative to the interior slanting portion 128B.

According to some embodiments of the invention, the upper sidewalls 123A of the container cap 120 may be mirror images of each other. In other embodiments, the upper sidewalls 123A may include different slopes or different shapes than that of the opposite upper sidewall 123A. Similarly, the upper sidewalls 123B of the container cap 120 may be mirror images of each other. In other embodiments, the upper sidewalls 123B may include different slopes or different shapes than that of the opposite upper sidewall 123B. In still other embodiments of the invention, the upper sidewalls 123B of the second pair of openings 122B may include a rearward upper sidewall 123B having a different slope than its opposing upper sidewall 123B.

A container cap 120 according to various embodiments of the invention may also include a projection 150 extending from the top surface 130 into an interior of the container cap 120 defined by the side wall 140. The projection 150 may include a ring shape having a circular shape or circumference. The distance or size of the projection 150 into an interior space defined by side wall 140 is not limited. However, in some embodiments, the projection 150 may extend into the interior space defined by the side wall 140 such that the projection 150 may be viewed through one or more openings 122 in the container cap 120. According to some embodiments of the invention, a projection 150 in a container cap 120 may be configured to mate with a container to which the container cap 120 is connected. The projection 150 may seal or help to seal the container cap 120 to a container.

According to certain embodiments of the invention, a container cap 120 may include a first pair of openings 122A and a second pair of openings 122B. The first pair of openings 122A may be positioned such that they are a mirror image of each other with respect to an axis through the container cap 120 between each of the openings 122A in the first pair of openings 122A. Similarly, the second pair of openings 122B may be positioned such that they are a mirror image of each other with respect to an axis through the container cap 120 between each of the openings 122B of the second pair of openings 122B. In some embodiments of the invention, the first pair of openings 122A and second pair of openings 122B may be formed in the container cap 120 such that the openings are not symmetrical. For example, as illustrated in FIG. 15, angle b may be different than angle a as illustrated.

According to various embodiments of the invention, a container cap 120 may be fitted to a container closure 200. A container closure 200 may be configured on a container 210 as illustrated in FIGS. 9 through 14. The container closure 200 may be integrally formed with an opening in a container 210.

According to various embodiments of the invention, a container closure 200 may include an opening 290 in a container 210 defined by a side wall 240 of the container 210. The side wall 240 may define a circular opening 290 into the container 210 or any other shaped opening. The side wall 240 of the container 210 may also include one or more container closure projections 222. A first pair of projections 222A may be located in a front portion of the container closure 200 and a second pair of projections 222A may be located in a rear portion of the container closure 200. The closure projections 222 may be configured to mate with the openings 122 of a container cap 120 such that the container cap 120 will be securely fastened to the container 210.

According to various embodiments of the invention, the first pair of projections 222A may include a top projection 224A and two side projections 223A. The top projection 224A may be positioned near an upper surface of the side wall 240, closest to an opening 290 in the container 210. In some embodiments of the invention, the top projection 224A projects outwardly and downwardly from the top portion of the side wall 140 closest to the opening 290. In some embodiments, the top projection 224A may also slant radially away from the side wall 240. The side projections 223A may extend from the top projection 224A generally downwardly. The side projections 223A may include one or more slanting surfaces. In some embodiments of the invention, the side projections 223A may have different sizes such that one side projection 223A is longer or shorter than, or wider or narrower, than the corresponding side projection 223A. The side projections 223A, in combination with the top projection 224A, may also define a space into which an interior slanting portion 128A of a container cap 120 may be positioned. In some embodiments of the invention, an interior slanting portion 128A of a container cap 120 may be friction fit into the space defined by the side projections 223A and top projection 224A such that the container cap 120 may be secured to the container closure 200.

According to various embodiments of the invention, the second pair of projections 222B may include a top projection 224B and two side projections 223B. The top projection 224B may be positioned near an upper surface of the side wall 240, closest to an opening 290 in the container 210. In some embodiments of the invention, the top projection 224B projects outwardly and downwardly from the top portion of the side wall 140 closest to the opening 290. In some embodiments, the top projection 224B may also slant radially away from the side wall 240. The side projections 223B may extend from the top projection 224B generally downwardly. The side projections 223B may include one or more slanting surfaces. In some embodiments of the invention, the side projections 223B may have different sizes such that one side projection 223B is longer or shorter than, or wider or narrower, than the corresponding side projection 223B. The side projections 223B, in combination with the top projection 224B, may also define a space into which an interior slanting portion 128B of a container cap 120 may be positioned. In some embodiments of the invention, an interior slanting portion 128B of a container cap 120 may be friction fit into the space defined by the side projections 223B and top projection 224B such that the container cap 120 may be secured to the container closure 200.

According to particular embodiments of the invention, one or more side projections 223 may have a larger projection dimension than the other side projection 223 associated with a container closure projection 222. For example, a forwardly located side projection 223 may project a distance C away from the side wall 240 while a corresponding side projection 223 may project a distance D away from the side wall 240; where distance D is greater than distance C. When portions of one or more interior side walls 129 of a container cap 120 are positioned against side projections 223, the difference in projection dimensions of the side projections 223 may allow the container cap 120 interior side walls 129 to slide past the side projection 223 having the smaller projection dimension. Thus, according to some embodiments of the invention, when the interior side walls 129 of a container cap 120 are mated with the side projections 223 of a container closure 200, the dimensions of the side projections 223 may allow the container cap 120 to be removed from the container closure 200.

While the container closure projections 222 of the container closure 200 may be constructed in many various configurations to mate with a container cap 120. It is understood that the dimensions and configurations of a container closure 200 may be scaled up or down as required to form a container closure 200 to fit to a container cap 120 according to embodiments of the invention.

According to certain embodiments of the invention, a container cap 120 may be fitted to a container closure 200. In some embodiments of the invention, a container cap 120 may be forcibly attached to the container cap 200. For example, in some embodiments the openings 122 of a container cap 120 may be aligned with the container closure projections 222 and the container cap 120 forcibly pushed onto the container closure 200 such that the interior slanting portions 128 of the openings 122 are positioned in the space defined by the container closure projections 222. In some embodiments, the first pair of openings 122A may be aligned with the first pair of projections 222A and the second pair of openings 122B may be aligned with the second pair of projections 222B. Once aligned, the container cap 120 may be forced onto the container closure 200 such that the container cap 120 and container closure 200 are frictionally mated or fitted together.

According to other embodiments of the invention, the openings 122 of the container cap 120 may be misaligned with the container closure projections 222 of the container closure 200. The container cap 120 may be forced onto the container closure 200 and then rotated such that the interior slanting portions 128 of the openings 122 are positioned in the space defined by the container closure projections 222 on the container closure 200. For example, the container cap 120 may be forced onto the container closure 200 in a position where the openings 122 and container closure projections 222 are misaligned and the container cap 120, the container closure 200, or both the container cap 120 and container closure 200 may be rotated to align the openings 122 and the container closure projections 222.

For example, in certain embodiments of the invention, a container cap 120 may be fitted to or mated with a container closure 200 in a bayonet fitting process. The container cap 120 may be forced onto the container closure 200, locking the container cap 120 onto the container closure. In other embodiments, the mating of a container cap 120 with a container closure 200 may involve a bayonet style combination of the container cap 120 with the container closure 200 followed by a rotational motion to mate the container cap 120 and the container closure 200 together.

While various methods for attaching the container cap 120 to the container closure 200 are described herein, it is understood that other methods could also be used and that the embodiments of the invention are not limited.

According to various other embodiments of the invention, a container attachment 1700 may be attached to a container 1710 with a container cap 1720 as illustrated in FIG. 17. In some embodiments of the invention the container cap 1720 may be removeably attached to the container attachment 1700. In other embodiments of the invention, the container cap 1720 may be molded to or otherwise permanently attached to the container attachment 1700. In other embodiments, the container cap 1720 may be an integral part of the container attachment 1700.

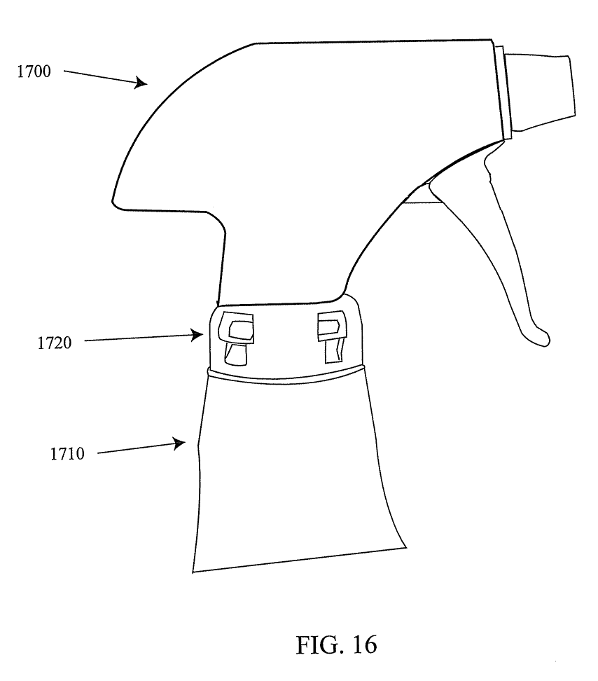

The container attachment 1700 may be attached to a container 1710 as illustrated in FIG. 16 by, for example, forcing the container cap 1720 and container attachment 1700 onto a container closure of the container 1710. A bayonet-type attachment may be used where openings in the container cap 1720 are aligned with projections in the container closure, followed by the forcible connection of the container cap 1720 to the container closure. In other embodiments, the container cap 1720 may be forced onto the container closure and then rotated to mate the container cap 1720 to the container 1710.

Containers according to various embodiments of the invention are not limited and may include any container, bottle, jug, tube, or other device which may be used to temporarily or permanently hold a fluid, powder, gas, or other material. In addition, container caps 120 according to embodiments of the invention may include any container caps, bottle caps, jug caps, tube caps, closure devices, or other devices that may be used to close a container or to attach a container attachment to the container. Container attachments may include any attachment capable of being attached to a container, including, but not limited to, trigger sprayers, pumps, misters, nozzles, valves, and other devices for communicating a fluid, powder, gas, or other material from within a container to a location outside of the container.

Container closure systems according to various embodiments of the invention may also be used with other closure systems. For example, a cap and container closure configuration may be modified to be used with a transport system for transporting a fluid, gas, powder, or combination thereof through the transport system. For example, a hose or pipe end may be configured with a container closure configuration such as that illustrated in FIGS. 9 through 14 to allow the hose or pipe end to be mated with an attachment using a container cap 120 or closure cap such as those illustrated in FIGS. 1 through 8.

According to other embodiments of the invention, openings such as a first pair of openings 122A and a second pair of openings 122B may be formed in a shroud of a trigger sprayer or pump such that a container cap 120 is unnecessary because a container closure 200 could mate with the openings 122A and 122B in the shroud of the trigger sprayer or pump. In other embodiments of the invention, a container cap 120 may be integrated or formed as an integral part of a shroud of a trigger sprayer or pump such that a separate container cap 120 is not required to mate with a container closure 200.

Having thus described certain particular embodiments of the invention, the invention is not limited to these described embodiments. Rather, the invention is limited only by the appended claims, which include within their scope all equivalent devices or methods which operate according to the principles of the invention as described.

What is claimed is:

1. A container closure system, comprising:
a container cap, comprising:
at least one opening, wherein the at least one opening defines an interior projection into
an interior of the container cap;
a container closure, comprising:
at least one projection defining a space configured to mate with the interior projection of the container cap.

2. The container closure system of claim 1, further comprising a container attachment selected from the group consisting of a trigger sprayer, a pump, a valve, a mister, and a nozzle.

3. A cap for a container, comprising:
a first pair of openings;
a first pair of interior projections;
a second pair of openings; and
a second pair of interior projections.

4. A method of attaching a container cap to a container, comprising:
providing a container, wherein the container comprises a container closure having at least one projection;
providing a container cap, wherein the container cap comprises at least one opening; and
bayoneting the container cap onto the container closure.

5. The method of claim 4, further comprising providing a container attachment wherein the container attachment is connected to the container cap.

6. The method of claim 5, wherein providing a container attachment further comprises providing a container attachment selected from the group consisting of a trigger sprayer, a pump, a valve, a mister, and a nozzle.
